(19) United States
(12) Patent Application Publication
(10) Pub. No.: US 2025/0321053 A1
(43) Pub. Date: Oct. 16, 2025

(54) SENSOR PORT ASSEMBLY FOR A METALLURGICAL FURNACE

(71) Applicant: Systems Spray-Cooled, Inc., Smyrna, TN (US)

(72) Inventor: Scott A. FERGUSON, Murfreesboro, TN (US)

(21) Appl. No.: 18/633,401

(22) Filed: Apr. 11, 2024

(51) Int. Cl. F27B 3/28

(52) U.S. Cl. CPC F27B 3/28

(57) ABSTRACT

An apparatus is disclosed for a metallurgical furnace having a sensor port assembly for sensing an interior volume of the metallurgical furnace. The sensor port assembly has a sensor housing. A first assembly tube having a first end coupled to the sensor housing and a second end. The sensor port assembly has a second assembly tube having a third end and a fourth end. The second end of the first assembly tube is coupled to the second assembly tube between the third end and the fourth end. The second assembly tube has a second interior diameter fluidly coupled to a first interior diameter of the first assembly tube. An actuator housing is coupled to the fourth end of the second assembly tube. The actuator housing is coupled to a piston moveable from a first position between the fourth end and the junction and second position exiting the third end.

### BACKGROUND OF THE DISCLOSURE

### Field of the Disclosure

Embodiments of the present disclosure relates generally to a metallurgical furnace, particularly a metallurgical furnace having a sensor port disposed through the sidewall.

### Description of the Related Art

Metallurgical furnaces (e.g., electric arc furnaces (EAF), ladle metallurgical furnaces (LMF) and the like) are used in the processing of molten metal materials. The electric arc furnace heats charged metal in the furnace by means of an electric arc from a graphite electrode and/or one or more oxy-fuel burners. The heating from both the electric current from the electrode passing through the charged metal material and the oxy-fuel burners form a molten bath of metal material. Melting of the metal material also forms slag (a stony waste material).

The simplest form of steel treatment in the metallurgical furnaces takes place when the mixing effect of the tapping stream is used to add deoxidizers, slag formers, and small amounts of alloying agents. These materials are either placed into the ladle before tapping or are injected into the tapping stream. Control over steel temperature can be achieved in a LMF with electrodes for arc heating with the ladle acting as the furnace shell. Argon gas and/or electromagnetic stirring is applied for better heat transfer. Most LMFs can raise the temperature of the steel by 4 degrees Celsius per minute to 6 degrees Celsius per minute by inducing a strong exothermic chemical reaction (for instance, by feeding aluminum and injecting oxygen) at the stirring station.

It is during processing that an understanding of the temperature, gases, and furnace conditions are desired to provide better and consistent yield. Sensors may be used to determine process conditions as well as the condition of the furnace. The intense heat and harsh environment of which a sensor be exposed to necessitates protection of the sensor from the molten material and the heat of the material. Conventionally, the roof may be removed or a door in the roof opened to insert a sensor for making measurements of process conditions. However, exposing the molten material to cool air changes the process conditions. Furthermore, opening the roof or door in the roof requires time and the use of safety measures which may require personnel to be removed from around the furnace.

Therefore, there is a need for an improved method of sensing process conditions in the furnace that does not disrupt or interfere with processing.

### SUMMARY

In one example, an apparatus is disclosed for a metallurgical furnace having a sensor port assembly for sensing an interior volume of the metallurgical furnace. The sensor port assembly has a sensor housing. A first assembly tube having a first end coupled to the sensor housing and a second end. The sensor port assembly has a second assembly tube having a third end and a fourth end. The second end of the first assembly tube is coupled to the second assembly tube between the third end and the fourth end. The second assembly tube has a second interior diameter fluidly coupled to a first interior diameter of the first assembly tube. An actuator housing is coupled to the fourth end of the second assembly tube. The actuator housing is coupled to a piston moveable from a first position between the fourth end and the junction and second position exiting the third end.

In one example, a metallurgical furnace has a roof and a ring shaped body. The roof is disposed on the ring shaped body and the roof and ring shaped body define an interior volume for processing molten material. The ring shaped body has a sidewall. The sidewall has a cover plate having an assembly opening disposed through the cover plate. The sidewall has a hot plate exposed to the interior volume. The cover plate is spaced from the hot plate forming an internal volume. The hot plate has a sensor opening disposed through the hot plate. A sensor port assembly is coupled to the sensor opening. The sensor port assembly having a sensor housing. The sensor port assembly has a first assembly tube having a first end coupled to the sensor housing and a second end, wherein the first assembly tube has a first interior diameter. The sensor port assembly has a second assembly tube having a third end and a fourth end. The second end of the first assembly tube is coupled to the second assembly tube between the third end and the fourth end. The third end of the second tube assembly is coupled to the sensor opening in the hot plate. The second assembly tube has a second interior diameter fluidly coupled at a junction to the first interior diameter of the first assembly tube. An actuator housing is coupled to fourth end of the second assembly tube. The actuator housing is coupled to a piston disposed in the second interior diameter and moveable from a first position between the fourth end and the junction and second position exiting the third end of the second assembly tube into the interior volume.

In yet another example, a method of operating a sensor in a metallurgical furnace is disclosed. The method begins by loading an interior volume of a metallurgical furnace with material which is melted. A clearing assembly, disposed substantially flush with a hole in a sidewall of the metallurgical furnace, is extended from a first tube and through the hole in the sidewall of the metallurgical furnace. The clearing assembly recedes back into the hole past a second tube. A sensor is extended out the second tube into the first tube and out the hole into the interior volume of the metallurgical furnace. The sensor detects a condition of the metallurgical furnace. The sensor is retracted out of the furnace and back into the second tube.

### BRIEF DESCRIPTION OF THE DRAWINGS

So that the way the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates a side view of a ladle metallurgical furnace (LMF).

FIG. 2 illustrates a side view of a metallurgical electric arc furnace (EAF).

FIG. 3 illustrates a cross section of a representative spray-cooled sidewall suitable for either the LMF or EAF disclosed in FIG. 1 or 2 having a sensor port assembly.

FIG. 4 illustrates a top perspective view for the sensor port assembly for the representative spray-cooled sidewall of FIG. 3.

FIG. 5 illustrates a method of operating a sensor in a metallurgical furnace.

FIGS. 6A-6D illustrate the sensor port assembly at various positions during operation of the method of FIG. 5.

### DETAILED DESCRIPTION

The present invention is directed to an electric arc metallurgical furnace, or other furnace such as a ladle metallurgical furnace (LMF), configured with a sidewall having a sensor port assembly disposed through the sidewall. A sensor, such as a camera, temperature, gas, optical or other sensor, is disposed in the sensor port assembly. The sensor port assembly is configured to protect the sensor from heat, and molten material when not sensing. Additionally, the sensor port assembly is designed to clear slag or other obstructions from the port to allow the sensor access to the interior volume of the metallurgical furnace for sensing while the metallurgical furnace is in operation, and to allow the sensor to safely be retracted and shielded from the interior volume of the metallurgical furnace when the sensor is not in use.

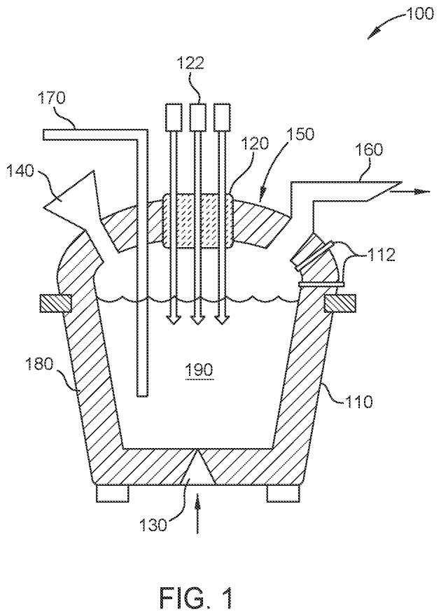

FIG. 1 illustrates a side view of a ladle metallurgical furnace (LMF) 100 having a roof 150 disposed on a body 110. The LMF 100 is suitable for melting scrap and other metals therein and may have temperatures exceeding 1000 degrees Celsius, such as temperatures of about 1250 degrees Celsius. The LMF 100 may utilize a spray-cool system, or other cooling system, to protect the roof 150 and the body 110 from these elevated temperatures so as to avoid damage such as structural melting, compromise of seals or valves and/or exceeding the yield strength for structural components. The LMF 100 may be disposed on rails or other transport mechanism to move the LMF 100 from one location to another. For example, the LMF 100 may be moved along the rails to provide the molten material therein to a secondary operation location, such as a casting operation.

The body 110 has a spray cooled sidewall 180. The sidewall 180 and/or the roof 150 may be spray cooled or be cooled using another method. The sidewall 180 is ring shaped and configured to support the roof 150 moveably disposed thereon. An interior volume 190 of the LMF 100 is enclosed by the roof 150 and the sidewall 180. The interior volume 190 may be loaded or charged with material, e.g., metal, scrap metal, or other meltable material, which is to be melted within the LMF 100.

An injection port 130 extends through the body 110 into the interior volume 190. The injection port 130 is configured to inject a fluid, such as argon gas, into the molten material disposed in the interior volume 190 of the LMF 100.

The roof 150 may be circular in shape when viewed from above. The roof 150 may have one or more of a hopper 140, a powder injection lance 170 and a central opening 120. The hopper 140 is configured to supply additives to the material in the interior volume 190. The powder injection lance 170 is similarly configured to supply additives to the material in the interior volume 190.

The central opening 120 may be formed through the roof 150. Electrodes 122 extend through the central opening 120 from a position above the roof 150 into the interior volume 190. During operation of the LMF 100, the electrodes 122 are lowered through the central opening 120 into the interior volume 190 of the LMF 100 to provide electric arc-generated heat to melt the material disposed in the interior volume 190.

The roof 150 may further include an exhaust port 160 to permit removal of fumes generated within the interior volume 190 of the LMF 100 during operation. Conventionally, the exhaust port 160 extends into the interior volume 190 for venting gases and fumes therein.

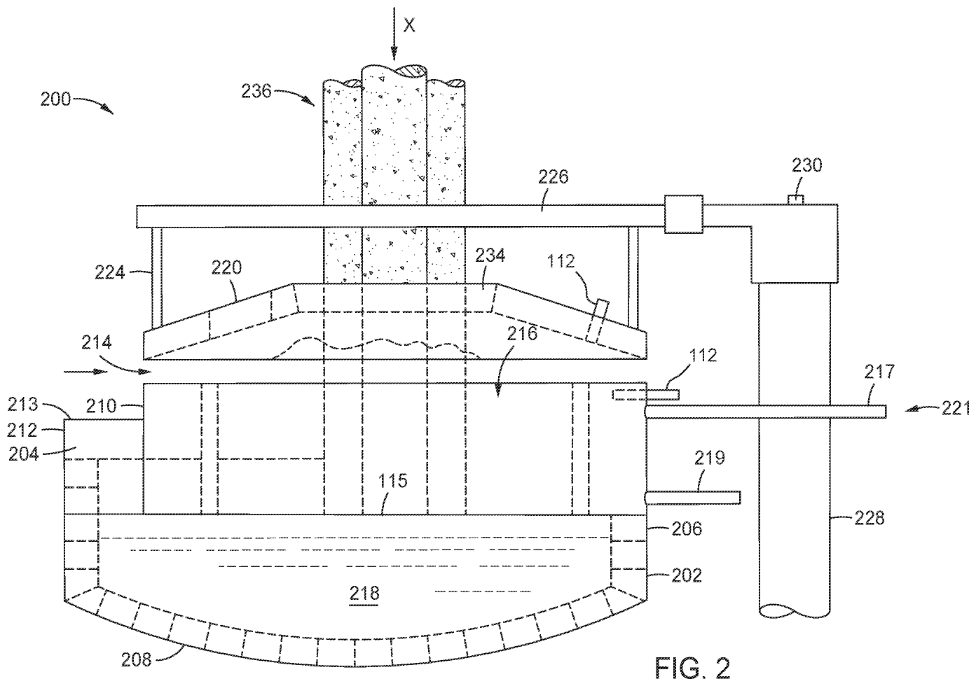

FIG. 2 illustrates a side view of a metallurgical electric arc furnace (EAF) 200. The EAF 200 has a body 202 and a roof 220. The roof 220 is supported on a sidewall 210 of the body 202. The roof 220 and/or sidewall 210 may be spray cooled or cooled using another technique. The body 202 may be generally cylindrical in shape and have an elliptical bottom. The body 202 may additionally include a step-up 204 to the tap side that extends outward from a main cylindrical portion of the body 202. The step-up 204 includes an upper sidewall 212 (which can be consider part of the sidewall 210) and a cover 213.

The body 202, including the step-up 204, has a hearth 206 that is lined with refractory brick 208. The sidewall 210 and upper sidewall 212 are disposed on top of the hearth 206. The sidewall 210 has a top flange 214 and a bottom flange 215. The roof 220 is moveably disposed on the top flange 214 of the sidewall 210. The bottom flange 215 of the sidewall 210 is removeably disposed on the hearth 206.

In some examples, a spray-cooling system 221 is utilized to control the temperature of the sidewall 210. The spray-cooling system 221 has an input cooling port 217 for introducing coolant into the sidewall 210 and a drain port 219 for emptying spent coolant from the sidewall 210.

The sidewall 210 of the body 202 generally surrounds an interior volume 216 of the EAF 200. The interior volume 216 may be loaded or charged with metal, scrap metal, or other meltable material which is to be melted within the hearth 206 of the EAF 200 to generate molten material 218.

The EAF 200, including the body 202 and the roof 220, is rotatable along a tilt axis about which the EAF 200 can tilt. The EAF 200 may be tilted in a first direction about the tilt axis toward the slag door (not shown) multiple times during a single batch melting process, sometimes referred to as a “heat”, to remove slag. Similarly, the EAF 200 may be tilted in a second direction about the tilt axis towards a tap spout multiple times during a single batch melting process including one final time to remove the molten material 218.

Roof lift members 224 may be attached at a first end to the roof 220. The roof lift members 224 may by chains, cables, ridged supports, or other suitable mechanisms for supporting the roof 220. The roof lift members 224 may be attached at a second end to one or more mast arms 226. The mast arms 226 extend horizontally and spread outward from a mast support 228. The mast support 228 may be supported by a mast post 230. The mast support 228 may rotate about the mast post 230. Alternately, the mast post 230 may rotate with the mast support 228 for moving the roof lift members 224. In yet other examples, roof lift members 224 may be aerially supported to move the roof 220. In one embodiment, the roof 220 is configured to swing or lift away from the sidewall 210. The roof 220 is lifted away from the sidewall 210 to expose the interior volume 216 of the EAF 200 through the top flange 214 of the sidewall 210 for loading material therein.

The roof 220 may be circular in shape. A central opening 234 may be formed through the roof 220. Electrodes 236 extend through the central opening 234 from a position above the roof 220 into the interior volume 216. During operation of the EAF 200, the electrodes 236 are lowered through the central opening 234 into the interior volume 216 of the EAF 200 to provide electric arc-generated heat to melt the molten material 218. The roof 220 may further include an exhaust port to permit removal of fumes generated within the interior volume 216 of the EAF 200 during operation.

The metallurgical furnaces, EAF 200 and LMF 100, are used to process molten metal material. During processing, the metallurgical furnaces rely on recipes for producing material which meets a desired formulation. For example, the recipe may require the injection of gases or material under high temperatures to meet a specification. Sensing metallurgical furnace operations and conditions, while the metallurgical furnace is in operation, help to ensure the resultant material is as specified. A sensor for detecting conditions and operations in the furnace place the sensor in the metallurgical furnace. The sensor may be a camera for inspecting the furnace, a thermocouple for detecting furnace temperature, a laser or other distance measuring device, and/or other suitable sensors. A sensor port assembly 112 is disclosed in the sidewall and/or roof of the metallurgical furnace 100/200 for allowing a sensor to operate inside the interior volume of the metallurgical furnace 100/200. In FIG. 1, the sensor port assembly 112 is shown disposed through the roof 150 and the sidewall 180 of the LMF 100. In FIG. 2, the sensor port assembly 112 is shown disposed through the roof 220 and the sidewall 210 of the EAF 200.

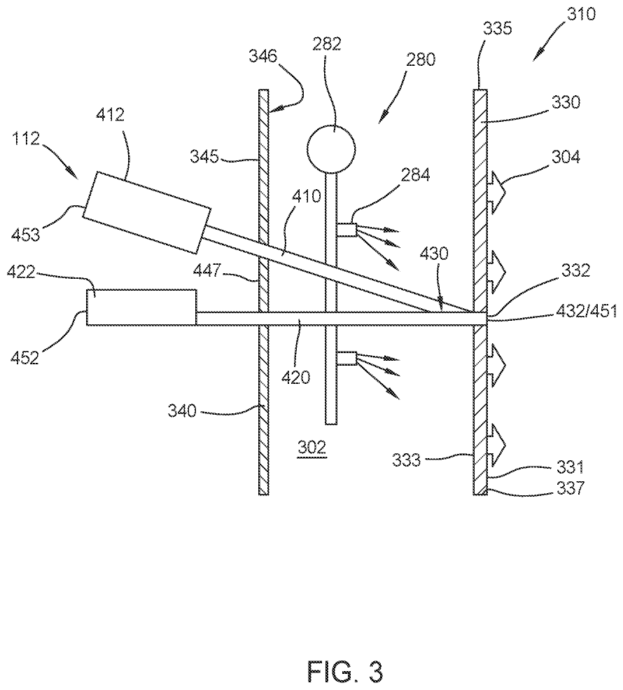

FIG. 3 illustrates a partial cross section of a representative wall section 310 that may be part of any of the roofs and/or sidewalls of either the LMF 100 or EAF 200 disclosed in FIG. 1 or 2 of which the sensor port assembly 112 resides. The representative wall section 310 comprises a hot plate 330 and a cover plate 340, both of which are shown in cross-section. The hot plate 330 is coupled in a spaced apart relation to the cover plate 340. The hot plate 330 and the cover plate 340 have a ring, oval or circular-shape, which forms the representative wall section 310 when configured as a sidewall. The hot plate 330 and the cover plate 340 may have a conical-shape, which forms the representative wall section 310 when configured as a roof. An inner volume 302 of the representative wall section 310 is defined between the hot plate 330 and the cover plate 340.

The cover plate 340 is fabricated from steel or other suitable material. The cover plate 340 has an exterior surface 345 and an interior surface 346. The exterior surface 345 faces the ambient environment where the LMF 100 or EAF 200 is utilized. The interior surface 346 is exposed to the inner volume 302 of the representative wall section 310 and faces the cover plate 340.

The hot plate 330 is fabricated from steel or other suitable material. The hot plate 330 has an inner surface 331 and an outer surface 333. The hot plate 330 has an upper surface 335 and a lower surface 337. In operation, the upper surface 335 is oriented above the lower surface 337. The inner surface 331 faces the interior volume 216 in the EAF 200 or the interior volume 190 in the LMF 100. The outer surface 333 is exposed to the inner volume 302 of the representative wall section 310 and faces the cover plate 340.

The optional spray cool system 380 is disposed in the inner volume 302 of the representative wall section 310 between the cover plate 340 and the hot plate 330. The spray cool system 380 has a header 382 and a plurality of nozzles 384. The plurality of nozzles 384 are coupled to the header 382. Liquid, such as water, is provided through the header 382 to the nozzles 384 such that the liquid may be sprayed through the nozzles 384 onto the outer surface 333 of the hot plate 330. The liquid is utilized to cool the hot plate 330 during operation of the metallurgical furnace to prevent damage to the representative wall section 310.

A plurality of slag retainers 304 may be coupled to the inner surface 331 of the hot plate 330. The slag retainers 304 project from the inner surface 331 of the hot plate 330 into the interior volume 190/216 of the metallurgical furnace. The slag retainers 304 is configured to trap slag produced by a batch melting process performed in the metallurgical furnace. In operation, the slag retainers 304 promote formation of slag on the hot plate 330.

The sensor port assembly 400 has first end 451, a second end 452 and a third end 453. The sensor port assembly 400 has a sensor housing 412 disposed at the third end 453 and an actuator housing 422 disposed at the second end 452. The sensor housing 412 is coupled to a first assembly tube 410. The actuator housing 422 is coupled to a second assembly tube 420. The second assembly tube 420 extends from the actuator housing to the first end 451 of the sensor port assembly 400. The first assembly tube 410 is coupled to the second assembly tube 420 at a junction 430. The junction 430 disposed at the end of the first assembly tube 410 and along the second assembly tube 420 prior to the first end 451. The first assembly tube 410 is hollow. The second assembly tube 420 is also hollow. A second hollow interior of the second assembly tube 420 is accessible directly by a first hollow interior of the first assembly tube 410 at the junction 430. In this manner, an item leaving the first assembly tube 410 at the junction 430 can enter the second assembly tube 420.

The hot plate 330 has a sensor opening 332. The sensor opening 332 extends from the inner surface 331 to the outer surface 333. The sensor opening 332 is exposed to the interior volume 216 in the EAF 200 or the interior volume 190 in the LMF 100. The first end 451 of the sensor port assembly 400 extends through the sensor opening 332. In one example, second assembly tube 420 of the sensor port assembly 400 is sealed to the hot plate 330 at the sensor opening 332. In this manner, a sensor may leave the second assembly tube 420 and enter the interior volume 190/216 of the LMF 100 or EAF 200 through the sensor opening 332 in the hot plate 330.

The first assembly tube 410 and second assembly tube 420 are at least partially disposed in the inner volume 302 of the representative wall section 310 between the cover plate 340 and the hot plate 330. Optionally, the first assembly tube 410 and the second assembly tube 420 are exposed to coolant sprayed by the optional spray cool system 380 in the inner volume 302 of the representative wall section 310.

The cover plate 340 has an assembly opening 347. The assembly opening 347 extends from the exterior surface 345 and the interior surface 346. The sensor port assembly 400 extends out the inner volume 302 through the assembly opening 347 to the ambient environment where the LMF 100 or EAF 200 is utilized. In one example, both the actuator housing 422 and the sensor housing 412 are outside the representative wall section 310 and accessible in the ambient environment. For example, a sensor may be replaced in the sensor housing 412 while the LMF 100 or EAF 200 is in operation.

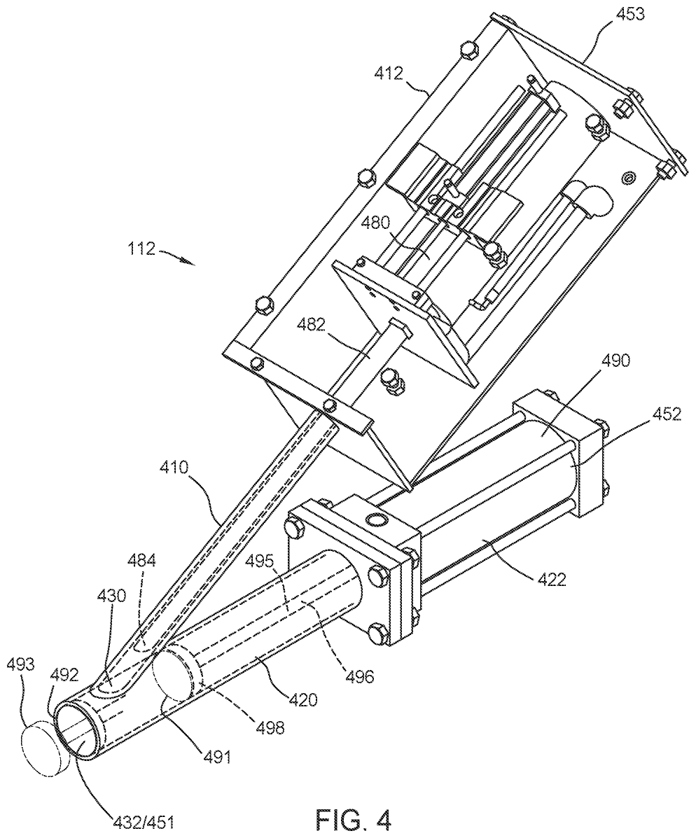

FIG. 4 illustrates a top perspective view for the sensor port assembly 400 for the representative wall section 310 of FIG. 3. The second assembly tube 420 may be formed from carbon steel or other temperature suitable material. Similarly, the first assembly tube 410 may be formed from carbon steel or other temperature suitable material. The second assembly tube 420 may be of a larger diameter than the first assembly tube 410. Alternately, the second assembly tube 420 may have the same diameter as the first assembly tube 410.

The second assembly tube 420 may be a schedule 40 pipe having a nominal size between about 2.5 inches and about 3.5 inches. The second assembly tube 420 may have an external diameter between about 2.875 inches and about 4.000 inches. The second assembly tube 420 may have a hollow 432, i.e., an internal diameter, between about 2.500 inches and about 3.625 inches.

The first assembly tube 410 may be a schedule 80 pipe having a nominal size between about 1.0 inch and about 2.0 inches. The first assembly tube 410 may have an external diameter between about 1.315 inches and about 2.375 inches. The first assembly tube 410 may have an internal diameter between about 0.800 inches and about 2.000 inches.

The second assembly tube 420 is larger than the first assembly tube 410 to allow passage of a sensor head 484 from the first assembly tube 410 into the second assembly tube 420. In one example, the second assembly tube 420 is a steel schedule 40 pipe having a nominal size of about 3.0 inches with an internal diameter of about 3.06 inches. In one example, the first assembly tube 410 is a steel schedule 80 pipe having a nominal size of about 1.25 inches with an internal diameter of about 1.278 inches.

The actuator housing 422 includes an actuator 490. The actuator 490 is coupled to a clearing assembly 495. The actuator 490 may be a linear actuator, stepper motor, a hydraulic cylinder, a pneumatic cylinder or other suitable device for imparting linear motion. The clearing assembly 495 has a connecting rod 496 and a piston 498. The piston 498 is sized to fit inside the hollow 432 of the second assembly tube 420. For example, the piston 498 may have an outside diameter smaller than the hollow 432, i.e., inside diameter, of the second assembly tube 420. The actuator 490 is configured to move the piston 498 through a range of positions that include a far position 493, an intermediate position 492 and a proximal position 491. When the piston 498 is in the intermediate position 492, the piston 498 is disposed at the first end 451 of the sensor port assembly 400. The piston 498 is configured in the intermediate position 492 to align substantially flush with the inner surface 331 of the hot plate 330 to close the sensor opening 332. The piston 498 is configured in the far position 493 to free slag from the sensor opening 332 in the hot plate 330. The piston 498 is configured in the proximal position 491 to open up the first assembly tube 410 to the sensor opening 332 in the hot plate 330.

In one example, the actuator 490 is a hydraulic cylinder. The actuator 490 is configured to move the piston 498 to push slag from in front of the sensor opening 332 in the hot plate 330. The actuator 490 is sized to have the power to break the slag away from the hot plate 330. Slag is an amalgamation of its components, there can be stress concentrations where the weakest material is bonded to the others, with SiO₂ being the weakest of the main compounds. As the temperature of a material increases, its ultimate strength decreases. Materials ultimate strength over temperature were tabulated and plotted to determine the material strength at various temperatures. Different ultimate strengths for certain temperatures were extrapolated to determine the force required by the actuator 490 sized to provide the needed force and pressure to break through the slag on the wall. The calculated pressure for the actuator 490 sufficient to remove the slag from the furnace wall was calculated to have an upper boundary of about 4500 psi. The actuator 490 causes the piston 498 to exert up to about 4500 psi of force to break away the slag from the sensor opening and allow the sensor head 484 to view the inner volume of the metallurgical furnace. The actuator then sets the piston 498 back flush with the hot plate 330 so that no/little slag may enter the second assembly tube 420.

The sensor housing 412 has a sensor 480. The sensor 480 may be equipped with a pushrod 482. The sensor head 484 is disposed at one end of the pushrod 482 and to the sensor 480 at the other end of the pushrod 482. The pushrod 482 is moveably disposed in the first assembly tube 410. The pushrod 482 is configured to move the sensor head 484 from the first assembly tube 410, through the second assembly tube 420 and sensor opening 332, and into the interior volume 190/216 of the metallurgical furnace.

In one example, the sensor 480 is a camera. The camera may be a visible light camera. In another example, the sensor 480 is an IR camera. In yet another example, the sensor 480 is a temperature sensor, such as a thermocouple or other temperature sensing device. The sensor head 484 detects a metric indicative of a condition of the furnace. In one example, the sensor head 484 may detect an internal operating temperature of the metallurgical furnace while the furnace is in operation. In another example, the sensor head 484 may visibly detect an internal condition of the metallurgical furnace such as the presence of slag, conditions of the refractory bricks, condition of the electrodes, condition of the sidewall and/or roof, among others. In another example, the sensor head 484 may be used to detect the presence of fumes or other gases.

The sensor port assembly 400 permits the sensor head 484 of the sensor 480 to be extended inside the metallurgical furnace while the metallurgical furnace is in operation with the roof closed. The ability to place the sensor head 484 inside the metallurgical furnace while in operation with the roof closed provides a number of benefits which include the ability to safely detect arcing and inspect the electrode without clearing personnel from the area around the metallurgical furnace.

The sensor 480 can be used to detect the need for preventative maintenance and reduce the need for recovering a fractured electrode. The sensor 480 can detect process conditions for improved quality of materials while in production where alterations can still be easily made. The data collected from the sensor 480 can be recorded and analyzed to enhance future production runs.

The sensor port assembly 400 is additionally configured to retract the sensor head 484 of the sensor 480 from inside the metallurgical furnace while the metallurgical furnace is in operation back into the first assembly tube 410. The pushrod 482 is configured to retract the sensor head 484 from inside the metallurgical furnace, through the second assembly tube 420 and into the first assembly tube 410. Furthermore, the actuator 490 is configured to move the piston 498 from inside the second assembly tube 420, past the first assembly tube 410 and flush with the sensor opening 332 in the hot plate 330. In this manner, the piston 498 protects the sensor port assembly 400, and in particular the sensor head 484, from damage due to slag or other environmental conditions from inside the metallurgical furnace 100/200.

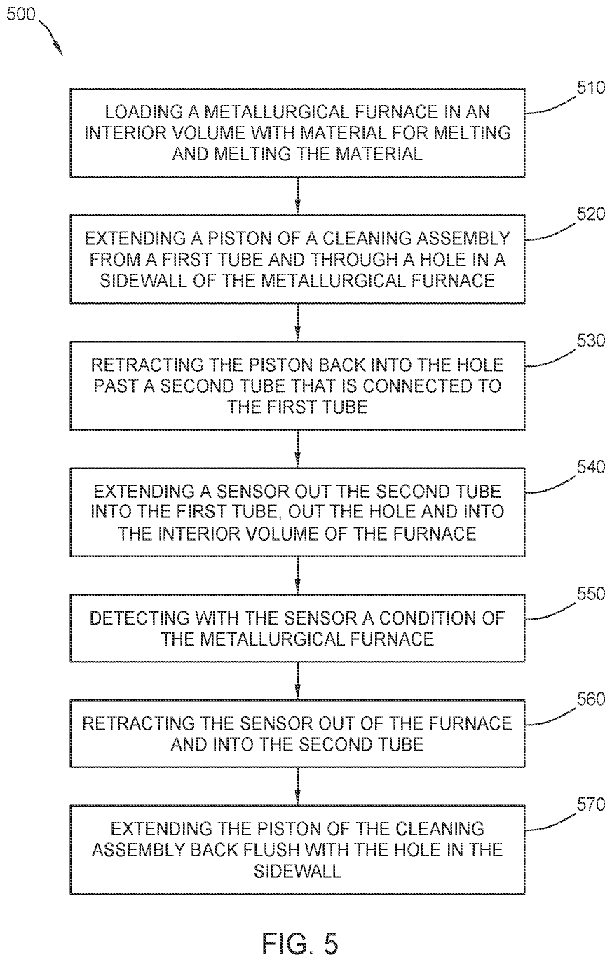

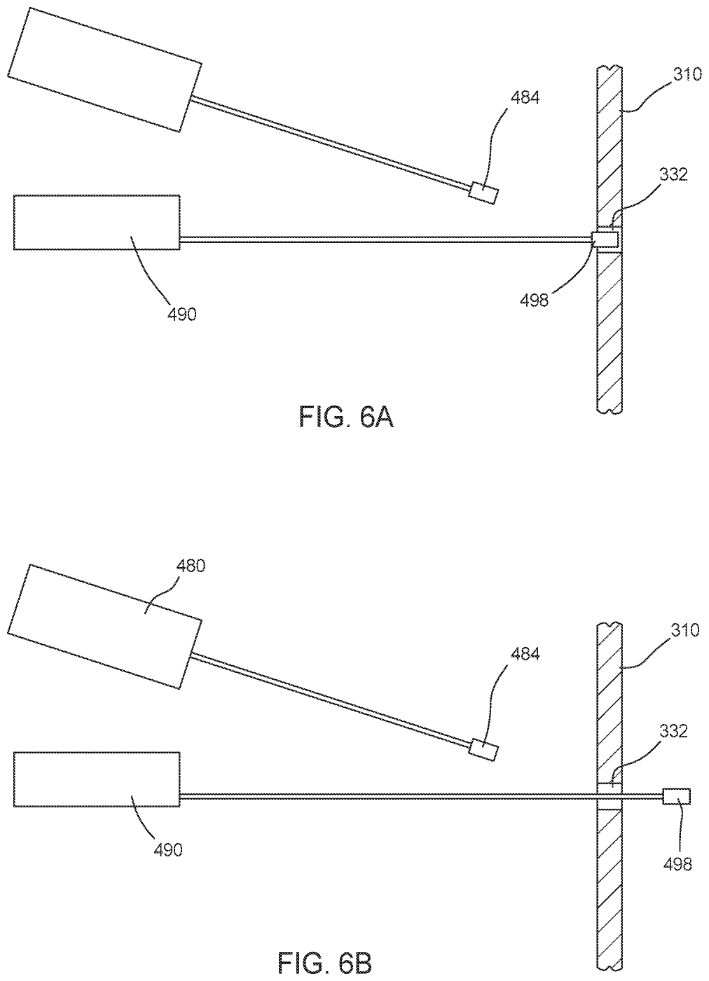

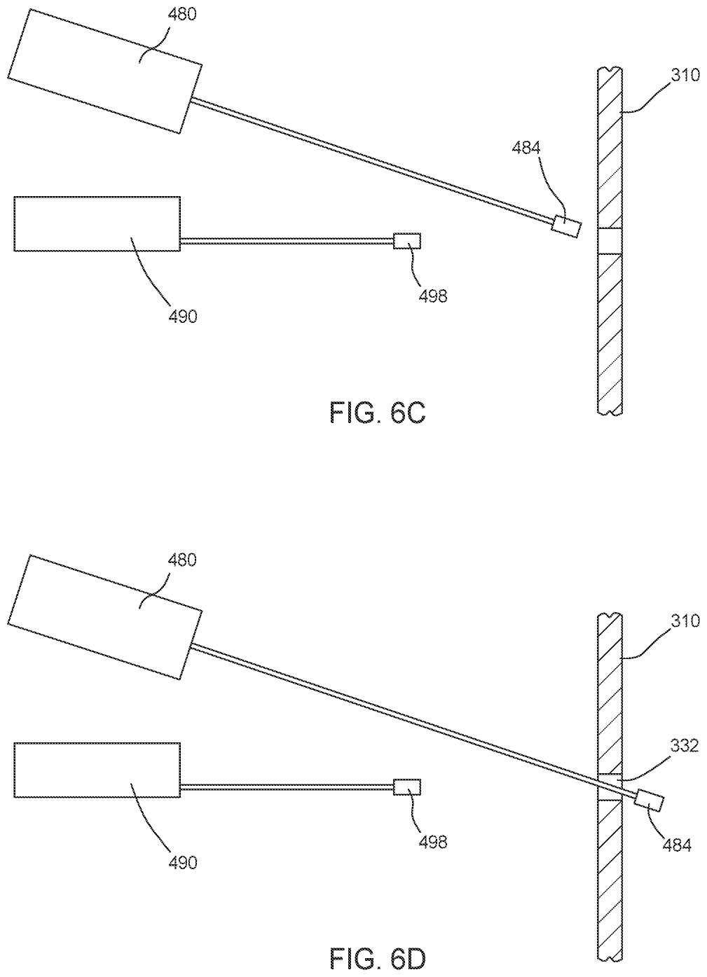

FIG. 5 illustrates a method 500 of operating a sensor in a metallurgical furnace. FIGS. 6A-6D illustrate the sensor port assembly at various positions during operation of the method 500 of FIG. 5. The method 500 begins at operation 510 wherein a metallurgical furnace is loaded in its interior volume with material which is melted. Electrodes, gas burners, or other techniques for heating the material is deployed to melt the material into a molten form. A recipe may be followed to mix specific amounts and types of material to obtain a molten material suitable for producing a specified alloy. During operation, the furnace may be tilted or molten material may otherwise come into contact with a hotplate of the sidewall enclosing the interior volume. Slag is a by-product of smelting ores and recycled metals. Slag forms on the hot plate to varying thickness which can protect the hot plate from the furnace high temperatures. During operation of the furnace, sensing of furnace conditions is desirable to ensure safety and proper recipe conditions are followed in forming the molten material.

In operation 520, a piston of a clearing assembly is extended from a position substantially flush with a hole in the sidewall of the furnace (as shown in FIG. 2A) through the hole in the sidewall and into the interior volume of the furnace (as shown in FIG. 6B). The clearing assembly includes a connecting rod and a piston. The connecting rod is moveably coupled to an actuator. For example, the connecting rod may be coupled to a pneumatic cylinder at one end. The connecting rod is fixedly coupled to a small piston at the other end. The small piston is flush with the exterior face of the hot plate. The piston is moved from flush with the hot plate into the interior volume of the metallurgical furnace. During operation of the furnace, slag forms along the exterior face of the hot plate and across the hole closed up by the piston. Moving the piston into the interior volume, breaks the slag to clear the slag away from the hole.

In operation 530, the clearing assembly is retracted back into the hole past a second tube (as shown in FIG. 2C). The second tube has a hollow which is fluidly coupled to the hollow of the first tube. An opening to the second tube into the first tube is between the piston and the hole in the hotplate. Retracting the piston of the cleaning assembly opens access from the second tube through the hole in the hot plate, now cleared of slag, to the interior volume of the furnace.

In operation 540, a sensor is extended out the second tube into the first tube proximate the hole in the sidewall as shown in FIG. 6D. In this position, the sensor detects conditions within the interior volume of the furnace. Optionally, as shown in FIG. 6D, the sensor is extended out the hole and into the interior volume of the furnace. The sensor is coupled an actuator to move a head of the sensor into the chamber environment. In one example, the sensor is a visible light camera. In another example, the sensor is an IR camera. In yet another example, the sensor is a thermocouple or other thermal sensing device.

In operation 550, the sensor detects a condition of the furnace. In one example, the sensor may detect an internal operating temperature of the metallurgical furnace while the furnace is in operation. In another example, the sensor may visibly detect an internal condition of the metallurgical furnace such as the presence of slag, conditions of the bricks. In another example, the sensor may be used to detect the presence of fumes or other gases.

In operation 560, the sensor is retracted out of the furnace and all the way back into the second tube. This operation places the sensor head clear of the first tube. The second tube may be cooled by spray cooling to reduce the temperature for protecting the sensor after leaving the hot interior volume of the metallurgical furnace.

In operation 570, the clearing assembly extends back flush with the hole. The piston is moved flush with the exterior surface of the hot plate to prevent slag or molten material from entering the first tube or the inner volume of the spray cooled sidewall. In one example, the sensor is removed from the sensor assembly and replaced with a different sensor while the metallurgical furnace is in operation. The different sensor may be of the same type. Alternately, the different sensor may be of a different type and the operations repeated to obtain different operational or furnace data.

While the foregoing is directed to embodiments of the present disclosure, other and further embodiments may be devised without departing from the basic scope thereof, and the scope thereof is determined by the claims that follow.

What is claimed is:

1. A sensor port assembly comprising:
a sensor housing;
a first assembly tube having a first end coupled to the sensor housing and a second end, wherein the first assembly tube has a first interior diameter;
a second assembly tube having a third end and a fourth end, wherein the second end of the first assembly tube is coupled to the second assembly tube at a junction defined between the third end and the fourth end; and
a piston slidably disposed in the second tube assembly, the piston moveable between a first position defined between the third end and the junction and second position defined between the fourth end and the junction.

2. The sensor port assembly of claim 1 further comprising:
a connecting rod coupled to the piston; and
an actuator coupled to the connecting rod, wherein the actuator is configured to linearly move the piston between the first and second positions, and to move the piston out of the second tube assembly beyond the fourth end.

3. The sensor port assembly of claim 2 wherein the actuator is operable to generate 4500 psi of force at the piston.

4. The sensor port assembly of claim 2 wherein the actuator is a hydraulic cylinder.

5. The sensor port assembly of claim 1 wherein the first assembly tube has an inner diameter smaller than an inner diameter of the second assembly tube.

6. The sensor port assembly of claim 1 wherein the second assembly tube is a schedule 40 steel pipe having a nominal size between about 2.5 inches and about 3.5 inches.

7. The sensor port assembly of claim 6 wherein the first assembly tube is a schedule 80 steel pipe having a nominal size less than the nominal size of the steel pipe comprising the second assembly tube.

8. A metallurgical furnace comprising:
a sidewall;
a roof disposed on the sidewall, the roof and sidewall defining an interior volume for processing molten material, at least one of the sidewall and roof comprising a wall section having a sensor opening;
a sensor port assembly coupled to the sensor opening, the sensor port assembly comprising:
a sensor housing;
a first assembly tube having a first end coupled to the sensor housing and a second end, wherein the first assembly tube has a first interior diameter;
a second assembly tube having a third end and a fourth end, wherein the second end of the first assembly tube is coupled to the second assembly tube at a junction defined between the third end and the fourth end; and
a piston slidably disposed in the second tube assembly, the piston moveable between a first position defined between the third end and the junction and second position defined between the fourth end and the junction.

9. The metallurgical furnace of claim 8 further comprising:
a connecting rod coupled to the piston; and
an actuator coupled to the connecting rod, wherein the actuator is configured to linearly move the piston between the first and second positions, and to move the piston out of the second tube assembly beyond the fourth end.

10. The metallurgical furnace of claim 9 wherein the actuator is operable to generate 4500 psi of force at the piston.

11. The metallurgical furnace of claim 9 wherein the actuator is a hydraulic cylinder.

12. The metallurgical furnace of claim 8, wherein the first assembly tube has an inner diameter smaller than an inner diameter of the second assembly tube.

13. The metallurgical furnace of claim 8, wherein the second assembly tube is a schedule 40 steel pipe having a nominal size between about 2.5 inches and about 3.5 inches.

14. The sensor port assembly of claim 13 wherein the first assembly tube is a schedule 80 steel pipe having a nominal size less than the nominal size of the steel pipe comprising the second assembly tube.

15. The metallurgical furnace of claim 8, wherein the wall section further comprising:
a cover plate having an assembly opening disposed through the cover plate; and
a hot plate exposed to the interior volume, the cover plate spaced from the hot plate forming an internal volume, the hot plate having a sensor opening disposed through the hot plate; and
a spray cool system disposed in the internal volume of the sidewall, wherein the spray cool system is configured to spray coolant on a portion of both the first assembly tube and the second assembly tube.

16. The metallurgical furnace of claim 8 further comprising:
a sensor moveably coupled to the sensor housing, wherein the sensor is moveable from the first assembly tube to the interior volume.

17. A method of operating a sensor in a metallurgical furnace comprising:
loading a metallurgical furnace in an interior volume with material for melting, and melting the material;
extending a piston of a clearing assembly from a first tube and through a hole in a sidewall of the metallurgical furnace;
retracting the piston back into the hole past a second tube that is connected to the first tube;
extending a sensor out the second tube into the first tube and out the hole into the interior volume of the furnace;
detecting with the sensor a condition of the metallurgical furnace; and
retracting the sensor out of the furnace and back into the second tube.

18. The method of claim 17 further comprising:
extending the clearing assembly back flush with the hole in the sidewall.

19. The method of claim 18, wherein extending the piston further comprises:
applying about 4500 psi of force to the piston.

20. The method of claim 18, wherein detecting the condition of the metallurgical furnace further comprises:
detecting the condition of the metallurgical furnace with a camera.
